(19) United States
(12) Patent Application Publication
(10) Pub. No.: US 2015/0183638 A1
(43) Pub. Date: Jul. 2, 2015

(54) METHOD FOR GENERATION OF HYDROGEN GAS

(71) Applicants: Rohm and Haas Company, Philadelphia, PA (US); Dow Global Technologies LLC, Midland, MI (US)

(72) Inventors: Michael B. Clark, JR., Coopersburg, PA (US); Richard Cummins, Lansdale, PA (US); Dean Millar, Midland, MI (US); John Yamamoto, Doylestown, PA (US)

(73) Assignee: DOW GLOBAL TECHNOLOGIES LLC, Midland, MI (US)

(21) Appl. No.: 14/414,320

(22) PCT Filed: Jul. 2, 2013
(86) PCT No.: PCT/US13/49000

§ 371 Date: Jan. 12, 2015

Related U.S. Application Data
(60) Provisional application No. 61/672,456, filed on Jul. 17, 2012.

(51) Int. Cl. C01B 3/06

(52) U.S. Cl. CPC C01B 3/065

(57) ABSTRACT

A method for generation of hydrogen by adding a liquid containing water and at least one organic acid to a solid composition containing at least one alkali metal borohydride and at least one carbon selected from activated carbon derived from coal and carbon black derived from peat.

This invention relates to a method for generation of hydrogen gas from a borohydride-containing formulation. This method is useful for hydrogen generation in fuel cells.

Borohydride-containing compositions are known as hydrogen sources for hydrogen fuel cells, usually in the form of aqueous solutions. Solid borohydride fuel compositions that generate hydrogen on addition of aqueous organic acid are prone to foaming during hydrogen generation, which can limit miniaturization of hydrogen generation cartridges for fuel cells. Solid borohydride-containing compositions useful for controlling foaming during hydrogen generation have been described. For example, U.S. Pub. No. 2010/0143240 discloses a composition comprising sodium borohydride, a base and a catalyst, which is combined with an aqueous component to produce hydrogen. However, this reference does not describe the improved formulation claimed in the present application.

The problem addressed by this invention is to find a method for generation of hydrogen gas from a borohydride-containing formulation that allows hydrogen generation with reduced foaming.

### STATEMENT OF INVENTION

The present invention provides a method for generation of hydrogen comprising adding a liquid comprising water and at least one organic acid to a solid composition comprising at least one alkali metal borohydride and at least one carbon selected from the group consisting of activated carbon derived from coal and carbon black derived from peat.

### DETAILED DESCRIPTION

Percentages are weight percentages (wt %) and temperatures are in ° C., unless specified otherwise. An “acid” is a compound with a pKₐ no greater than 6. An “organic acid” is an acid which contains carbon, preferably one which does not contain sulfur. A “base” is a compound with a pKₐ of at least 8 which is solid at 50° C. pKₐ values referred to herein are those found in standard tables of pKₐ values, usually measured at 20-25° C. “Activated carbon” is a form of carbon that has been processed to have a surface area in excess of 500 m²/g, as determined typically by nitrogen gas absorption (BET), and a partially oxidized surface. Typically activated carbon has an overall carbon content no greater than 94%, often no greater than 93%. Typically activated carbon has an overall oxygen content of at least 4%, often at least 4.5%. Activated carbon is produced from carbonaceous materials, e.g., nutshells, peat, wood, coir, lignite, coal (typically bituminous coal) and petroleum pitch. It can be produced by physical or chemical treatment. Physical treatment entails the combination of the following processes: carbonization, pyrolysis of carbon at temperatures in the range 600-900° C., under anoxic conditions, and exposure of the carbonized carbon with an oxidative atmosphere (carbon dioxide, oxygen, or steam) at temperatures above 250° C. Chemical activation entails, prior to carbonization, impregnating the raw material with certain chemicals: an acid, strong base, or a salt (e.g., phosphoric acid, potassium hydroxide, sodium hydroxide, calcium chloride, and zinc chloride 25%), followed by carbonizing at lower temperatures (450-900° C.). “Carbon black” is a material produced by the incomplete combustion of heavy petroleum products such as FCC tar, coal tar, ethylene cracking tar, and in some cases vegetable oil. Carbon black typically has a higher carbon content than that of activated carbon, e.g., the carbon content of carbon black is at least 93%, often at least 94%.

Preferably, the total amount of alkali metal borohydride(s) in the solid composition is at least 60%, preferably at least 65%, preferably at least 70%, preferably at least 75%; preferably no more than 90%, preferably no more than 88%, preferably no more than 86%, preferably no more than 84%, preferably no more than 82%, preferably no more than 80%. Preferably, the alkali metal borohydride comprises sodium borohydride (SBH) or potassium borohydride (KBH) or a mixture thereof, preferably sodium borohydride. Preferably, the solid composition further comprises at least one substance that catalyzes hydrolysis of borohydride, i.e., salts of transition metals in groups 8, 9 and 10; such as Co, Ru, Ni, Fe, Rh, Pd, Os, Ir, Pt, or mixtures thereof; and borides of Co and/or Ni. Preferably, a transition metal salt is soluble in water at 20° C. in an amount at least 1 g/100 g water, alternatively at least 2 g/100 g water, alternatively at least 5 g/100 g water, alternatively at least 10 g/100 g water, alternatively at least 20 g/100 g water. Particularly preferred catalysts are cobalt (II) and ruthenium(III), preferably as their chlorides. Preferably, no transition metals are present as zero-valent metals. In the solid composition, preferably the total amount of catalyst is no more than 15%, preferably no more than 13%, preferably no more than 12%, preferably no more than 11%, preferably no more than 10%; preferably at least 0.5%, preferably at least 1%, preferably at least 1.5%, preferably at least 2%, preferably at least 4%.

The solid composition comprises activated carbon derived from coal, carbon black derived from peat or a combination thereof. A carbon is “derived from” an indicated source material if it was produced by physical or chemical treatment of that source material. Information on the source of a carbon typically is available from the manufacturer. Preferably, the composition comprises activated carbon derived from coal. Preferably, the total amount of activated carbon derived from coal, carbon black derived from peat or a combination thereof in the solid composition is at least 5%, preferably at least 6%, preferably at least 7%, preferably at least 8%; preferably no more than 20%, preferably no more than 17%, preferably no more than 15%, preferably no more than 13%, preferably no more than 12%. Preferably, the activated carbon derived from coal, carbon black derived from peat or a combination thereof has a carbon content no more than 95%, preferably no more than 94.5%, preferably no more than 94%, preferably no more than 92%, preferably no more than 90%; preferably at least 75%, preferably at least 77%, preferably at least 79%. Preferably, the activated carbon derived from coal or carbon black derived from peat has a total oxygen content (organic and inorganic oxygen) of at least 4%, preferably at least 4.5%, preferably at least 5%; preferably no more than 15%, preferably no more than 13%, preferably no more than 11%, preferably no more than 9%.

Preferably, the solid composition further comprises at least one base. Preferably, the total amount of base(s) is no more than 12%, preferably no more than 11%, preferably no more than 10%, preferably no more than 9%, preferably no more than 8%, preferably no more than 7%. Preferably, the amount of base in the solid composition is at least 1%, preferably at least 2%, preferably at least 3%, preferably at least 4%. Preferably, the base is an alkali metal hydroxide, alkali metal alkoxide, alkaline earth alkoxide or combination thereof; preferably it is an alkali metal hydroxide, sodium or potassium methoxide, or mixture thereof; preferably sodium, lithium or potassium hydroxide, sodium or potassium methoxide, or a mixture thereof; preferably sodium hydroxide or potassium hydroxide; preferably sodium hydroxide. More than one alkali metal borohydride and more than one base may be present.

A liquid comprising water and at least one organic acid is added to the solid composition. Preferably, the liquid contains at least 50% water, preferably at least 60%, preferably at least 65%, preferably at least 70%, preferably at least 75%. Examples of organic acids include carboxylic acids, e.g., C₂-C₅ dicarboxylic acids, C₂-C₆ hydroxy carboxylic acids, C₂-C₆ hydroxy di- or tri-carboxylic acids or a combination thereof, e.g., malic acid, citric acid, tartaric acid, malonic acid and oxalic acid. Preferably, the total amount of organic acid(s) in the liquid is at least 5%, preferably at least 10%, preferably at least 12%, preferably at least 14%; preferably no more than 40%, preferably no more than 35%, preferably no more than 30%. Preferably, the liquid contains less than 5% or mineral acids or sulfonic acids, preferably less than 3%, preferably less than 1%, preferably less than 0.5%, preferably less than 0.2%, preferably less than 0.1%.

The solid composition of this invention may be in any convenient form. Examples of suitable solid forms include powder, granules, and compressed solid material. Preferably, powders have an average particle size less than 80 mesh (177 μm). Preferably, granules have an average particle size from 10 mesh (2000 μm) to 40 mesh (425 μm). Compressed solid material may have a size and shape determined by the equipment comprising the hydrogen generation system. Preferably, compressed solid material is in the form of a typical pellet or caplet used in other fields. The compaction pressure used to form compressed solid material is not critical.

Preferably, the liquid comprising water and an organic acid contains less than 5% of anything other than water and organic acid, preferably less than 4%, preferably less than 3%, preferably less than 2%, preferably less than 1%, preferably less than 0.5%.

Preferably, the water content of the solid composition is no more than 2%, preferably no more than 1%, preferably no more than 0.5%, preferably no more than 0.3%, preferably no more than 0.2%, preferably no more than 0.1%. Preferably, when the base comprises potassium hydroxide, the water content may be higher than these limits, providing the water is bound to the potassium hydroxide and the base does not melt below 50° C. Preferably, the solid composition contains no more than 8% of anything other than the borohydride, catalyst, carbon and the base, preferably no more than 6%, preferably no more than 4%, preferably no more than 2%, preferably no more than 1%. Other possible constituents of the solid composition include, e.g., catalysts, anti-foam agents and surfactants. Preferably, the solid composition is substantially or completely free of metal hydrides other than borohydrides, e.g., alkali metal or alkaline earth metal hydrides, MH or MH₂, respectively; and aluminum hydride compounds, e.g., MAlH₄. The term “substantially free of” means containing less than 1%, preferably less than 0.5%, preferably less than 0.2%, preferably less than 0.1%.

Preferably, the temperature of the solid composition and the liquid are in the range from −60° C. to 100° C., preferably from −50° C. to 50° C., preferably from −40° C. to 45° C., preferably from −30° C. to 45° C., preferably from −20° C. to 40° C. When the liquid activator comprises almost entirely water, temperatures below 0° C. still are attainable by including anti-freeze agents, such as alcohols or glycols in the aqueous solution. Aqueous catalyst solutions also may include anti-freeze agents. The rate of addition may vary depending on the desired rate of hydrogen generation. Preferred addition rates are in the range from 10 to 300 υL/min to generate a flow rate of 5 to 300 mL/min of hydrogen gas. Preferably, the mixture formed when the solid composition contacts the aqueous solution is not agitated.

The method of this invention allows generation of hydrogen at a useful rate with the capability of stopping said generation relatively quickly after stopping the addition of the aqueous solution. This capability is important in hydrogen fuel cells, where power generation on demand is a key concern. Inability to stop the flow of hydrogen is detrimental to rapid on/off operation of the fuel cell. Linearity of hydrogen generation over time and/or the amount of aqueous solution added is also an important capability in a hydrogen fuel cell.

### Examples

Equipment for rapidly screening the amount of foam generated from candidate fuel formulations consisted of a one-armed robot placed in a nitrogen purged enclosure. Up to 12 formulations could be evaluated per library. Impressionist control software (available from SYMYX Technologies Inc.) was programmed to deliver 20 μL of hydrolysis solution to 0.5 mL of fuel formulation. Individual 0.5 mL samples were loaded into reactors with a constant volume of 0.5 mL lightly packed powder using a modified 1 mL syringe (i.e., the total reactor volume was 1 mL). Powders were lightly packed by tapping the open end of the syringe into the powders 4 times, then dispersing the solids into the sample tubes. Weight measurements showed that this method was reproducible within each powder to about ±2.5 mg. A black and white digital image of the completed sample set was recorded. Image analyses were performed using DiamHTR™ analysis software. This software package allows the user to specify an area within each image for analysis and then determines the percent black and white pixels in each area. The amount of foam generated was taken as the percent black in images of dark colored formulations and the percent white in colorless formulations. Percent foam was calculated as the amount of foam as a percentage of the total sample container area. The results are presented below in Tables 1 and 2.

TABLE 1
High Throughput Data from NaBH₄ (SBH),
CoCl₂, RuCl₃, Activated carbon, NaOH

| Plate | Vial | | | | | Activated | Malic | Percent |
|---|---|---|---|---|---|---|---|---|
| No. | No. | CoCl₂ | RuCl₃ | NaOH | SBH | Carbon¹ | acid | Foam |
| 1 | 1 | 1.00 | 1.00 | 5.00 | 79.00 | 14.00 | 5 | 51 |
| 1 | 2 | 1.00 | 1.00 | 5.00 | 83.00 | 10.00 | 5 | 44 |
| 1 | 3 | 1.00 | 1.00 | 9.00 | 79.00 | 10.00 | 5 | 29 |
| 1 | 4 | 3.67 | 3.67 | 5.00 | 75.00 | 12.67 | 5 | 54 |
| 1 | 5 | 1.00 | 5.00 | 9.00 | 75.00 | 10.00 | 5 | 55 |
| 1 | 6 | 1.00 | 1.00 | 7.67 | 77.67 | 12.67 | 5 | 21 |
| 1 | 7 | 1.00 | 3.23 | 10.77 | 75.00 | 10.00 | 5 | 38 |
| 1 | 8 | 5.00 | 5.00 | 5.00 | 75.00 | 10.00 | 5 | 40 |
| 1 | 9 | 9.00 | 1.00 | 5.00 | 75.00 | 10.00 | 5 | 51 |
| 1 | 10 | 3.67 | 3.67 | 5.00 | 77.67 | 10.00 | 5 | 72 |
| 1 | 11 | 5.00 | 1.00 | 9.00 | 75.00 | 10.00 | 5 | 25 |
| 1 | 12 | 3.67 | 3.67 | 7.67 | 75.00 | 10.00 | 5 | 57 |
| Plate | Vial | | | | | Activated | Malic | Percent |
| No. | No. | CoCl₂ | RuCl₃ | NaOH | SBH | Carbon | acid | Foam |
| 2 | 1 | 3.67 | 3.67 | 5.00 | 77.67 | 10.00 | 5 | 45 |
| 2 | 2 | 3.67 | 1.00 | 7.67 | 75.00 | 12.67 | 5 | 68 |
| 2 | 3 | 1.00 | 1.00 | 5.00 | 75.00 | 18.00 | 5 | 64 |
| 2 | 4 | 1.00 | 3.67 | 7.67 | 77.67 | 10.00 | 5 | 26 |
| 2 | 5 | 6.77 | 3.23 | 5.00 | 75.00 | 10.00 | 5 | 39 |
| 2 | 6 | 5.00 | 1.00 | 5.00 | 79.00 | 10.00 | 5 | 51 |
| 2 | 7 | 5.00 | 1.00 | 5.00 | 75.00 | 14.00 | 5 | 52 |
| 2 | 8 | 1.00 | 3.67 | 7.67 | 75.00 | 12.67 | 5 | 69 |
| 2 | 9 | 1.00 | 5.00 | 5.00 | 75.00 | 14.00 | 5 | 52 |
| 2 | 10 | 1.00 | 1.00 | 13.00 | 75.00 | 10.00 | 5 | 51 |
| 2 | 11 | 1.00 | 5.00 | 5.00 | 79.00 | 10.00 | 5 | 34 |
| 2 | 12 | 3.67 | 1.00 | 7.67 | 77.67 | 10.00 | 5 | 48 |
| 3 | 1 | 1.00 | 3.67 | 5.00 | 77.67 | 12.67 | 5 | 74 |
| 3 | 2 | 5.00 | 1.00 | 9.00 | 75.00 | 10.00 | 5 | 78 |
| 3 | 3 | 3.67 | 1.00 | 5.00 | 77.67 | 12.67 | 5 | 71 |
| 3 | 4 | 1.00 | 1.00 | 5.00 | 83.00 | 10.00 | 5 | 76 |
| 3 | 5 | 1.00 | 3.23 | 5.00 | 75.00 | 15.77 | 5 | 79 |
| 3 | 6 | 1.00 | 1.00 | 9.00 | 75.00 | 14.00 | 5 | 68 |
| 4 | 1 | 2.85 | 5.00 | 5.00 | 77.15 | 10.00 | 10 | 45 |
| 4 | 2 | 1.00 | 3.36 | 7.90 | 77.73 | 10.00 | 10 | 53 |
| 4 | 3 | 1.00 | 1.00 | 5.00 | 75.00 | 18.00 | 10 | 33 |
| 4 | 4 | 1.00 | 3.36 | 5.00 | 77.73 | 12.90 | 10 | 55 |
| 4 | 5 | 3.67 | 1.00 | 5.00 | 77.67 | 12.67 | 10 | 35 |
| 4 | 6 | 1.00 | 1.00 | 5.00 | 79.00 | 14.00 | 10 | 45 |
| 4 | 7 | 1.00 | 5.00 | 9.00 | 75.00 | 10.00 | 10 | 34 |
| 4 | 8 | 3.67 | 1.00 | 5.00 | 77.67 | 12.67 | 10 | 46 |
| 4 | 9 | 1.00 | 1.00 | 13.00 | 75.00 | 10.00 | 10 | 53 |
| 4 | 10 | 1.00 | 1.00 | 9.00 | 79.00 | 10.00 | 10 | 25 |
| 4 | 11 | 5.00 | 1.00 | 5.00 | 75.00 | 14.00 | 10 | 61 |
| 4 | 12 | 1.00 | 1.00 | 7.67 | 77.67 | 12.67 | 10 | 24 |
| 5 | 1 | 1.00 | 3.46 | 7.77 | 75.00 | 12.77 | 10 | 35 |
| 5 | 2 | 1.00 | 3.36 | 5.00 | 77.73 | 12.90 | 10 | 39 |
| 5 | 3 | 9.00 | 1.00 | 5.00 | 75.00 | 10.00 | 10 | 35 |
| 5 | 4 | 4.08 | 3.10 | 5.00 | 77.83 | 10.00 | 10 | 48 |
| 5 | 5 | 1.00 | 5.00 | 6.18 | 76.63 | 11.18 | 10 | 44 |
| 5 | 6 | 3.67 | 1.00 | 7.67 | 75.00 | 12.67 | 10 | 55 |
| 5 | 7 | 1.00 | 5.00 | 6.18 | 76.63 | 11.18 | 10 | 16 |
| 5 | 8 | 1.00 | 5.00 | 5.00 | 75.00 | 14.00 | 10 | 32 |
| 5 | 9 | 3.67 | 3.67 | 5.00 | 75.00 | 12.67 | 10 | 56 |
| 5 | 10 | 1.00 | 4.30 | 5.00 | 79.70 | 10.00 | 10 | 58 |
| 5 | 11 | 5.00 | 1.00 | 9.00 | 75.00 | 10.00 | 10 | 69 |
| 5 | 12 | 5.30 | 4.70 | 5.00 | 75.00 | 10.00 | 10 | 34 |
| 6 | 1 | 5.00 | 1.00 | 5.00 | 79.00 | 10.00 | 10 | 68 |
| 6 | 2 | 3.67 | 1.00 | 7.67 | 77.67 | 10.00 | 10 | 81 |
| 6 | 3 | 1.00 | 1.00 | 9.00 | 75.00 | 14.00 | 10 | 87 |
| 6 | 4 | 3.67 | 3.67 | 7.67 | 75.00 | 10.00 | 10 | 59 |
| 6 | 5 | 1.00 | 1.00 | 5.00 | 83.00 | 10.00 | 10 | 31 |
| 7 | 1 | 9.00 | 1.00 | 5.00 | 75.00 | 10.00 | 15 | 31 |
| 7 | 2 | 1.00 | 3.67 | 5.00 | 77.67 | 12.67 | 15 | 35 |
| 7 | 3 | 3.67 | 1.00 | 7.67 | 75.00 | 12.67 | 15 | 59 |
| 7 | 4 | 1.00 | 3.67 | 7.67 | 75.00 | 12.67 | 15 | 55 |
| 7 | 5 | 9.00 | 1.00 | 5.00 | 75.00 | 10.00 | 15 | 61 |
| 7 | 6 | 1.00 | 1.00 | 7.67 | 77.67 | 12.67 | 15 | 23 |
| 7 | 7 | 5.00 | 1.00 | 5.00 | 79.00 | 10.00 | 15 | 32 |
| 7 | 8 | 3.67 | 3.67 | 5.00 | 77.67 | 10.00 | 15 | 24 |
| 7 | 9 | 3.31 | 5.00 | 5.00 | 75.00 | 11.69 | 15 | 39 |
| 7 | 10 | 5.00 | 1.00 | 9.00 | 75.00 | 10.00 | 15 | 50 |
| 7 | 11 | 3.67 | 1.00 | 5.00 | 77.67 | 12.67 | 15 | 58 |
| 7 | 12 | 1.00 | 1.00 | 5.00 | 83.00 | 10.00 | 15 | 22 |
| 8 | 1 | 3.31 | 5.00 | 6.69 | 75.00 | 10.00 | 15 | 44 |
| 8 | 2 | 1.00 | 3.67 | 7.67 | 77.67 | 10.00 | 15 | 31 |
| 8 | 3 | 6.12 | 3.88 | 5.00 | 75.00 | 10.00 | 15 | 33 |
| 8 | 4 | 3.70 | 3.09 | 5.00 | 75.00 | 13.22 | 15 | 32 |
| 8 | 5 | 1.00 | 1.00 | 9.00 | 75.00 | 14.00 | 15 | 29 |
| 8 | 6 | 3.67 | 3.67 | 5.00 | 77.67 | 10.00 | 15 | 24 |
| 8 | 7 | 1.00 | 1.00 | 13.00 | 75.00 | 10.00 | 15 | 18 |
| 8 | 8 | 1.00 | 1.00 | 9.00 | 79.00 | 10.00 | 15 | 25 |
| 8 | 9 | 1.00 | 3.67 | 5.00 | 77.67 | 12.67 | 15 | 24 |
| 8 | 10 | 3.70 | 3.09 | 8.22 | 75.00 | 10.00 | 15 | 52 |
| 8 | 11 | 1.00 | 4.80 | 9.20 | 75.00 | 10.00 | 15 | 63 |
| 8 | 12 | 1.00 | 1.00 | 5.00 | 75.00 | 18.00 | 15 | 34 |
| 9 | 1 | 3.67 | 1.00 | 7.67 | 77.67 | 10.00 | 15 | 64 |
| 9 | 2 | 6.12 | 3.88 | 5.00 | 75.00 | 10.00 | 15 | 36 |
| 9 | 3 | 5.00 | 1.00 | 5.00 | 75.00 | 14.00 | 15 | 53 |
| 9 | 4 | 1.00 | 3.67 | 7.67 | 77.67 | 10.00 | 15 | 27 |
| 9 | 5 | 1.00 | 1.00 | 5.00 | 79.00 | 14.00 | 15 | 38 |
| 9 | 6 | 1.00 | 4.80 | 5.00 | 75.00 | 14.20 | 15 | 58 |
| 9 | 7 | 1.00 | 5.00 | 5.00 | 79.00 | 10.00 | 15 | 37 |
| 9 | 8 | 5.00 | 1.00 | 5.00 | 79.00 | 10.00 | 15 | 20 |
| 10 | 1 | 3.72 | 3.47 | 7.81 | 75.00 | 10.00 | 20 | 47 |
| 10 | 2 | 1.00 | 1.00 | 13.00 | 75.00 | 10.00 | 20 | 40 |
| 10 | 3 | 1.00 | 1.00 | 13.00 | 75.00 | 10.00 | 20 | 16 |
| 10 | 4 | 3.67 | 1.00 | 7.67 | 77.67 | 10.00 | 20 | 19 |
| 10 | 5 | 1.00 | 5.00 | 5.00 | 75.00 | 14.00 | 20 | 36 |
| 10 | 6 | 5.00 | 5.00 | 5.00 | 75.00 | 10.00 | 20 | 44 |
| 10 | 7 | 5.01 | 1.00 | 8.99 | 75.00 | 10.00 | 20 | 23 |
| 10 | 8 | 1.00 | 1.00 | 5.00 | 75.00 | 18.00 | 20 | 37 |
| 10 | 9 | 2.22 | 5.00 | 5.93 | 75.93 | 10.93 | 20 | 51 |
| 10 | 10 | 3.72 | 3.47 | 5.00 | 75.00 | 12.81 | 20 | 33 |
| 10 | 11 | 5.01 | 1.00 | 5.00 | 78.99 | 10.00 | 20 | 33 |
| 10 | 12 | 1.00 | 1.00 | 5.00 | 79.00 | 14.00 | 20 | 52 |
| 11 | 1 | 1.00 | 5.00 | 9.00 | 75.00 | 10.00 | 20 | 37 |
| 11 | 2 | 3.72 | 3.47 | 5.00 | 77.81 | 10.00 | 20 | 41 |
| 11 | 3 | 1.00 | 3.53 | 7.74 | 77.74 | 10.00 | 20 | 32 |
| 11 | 4 | 1.00 | 5.00 | 5.00 | 79.00 | 10.00 | 20 | 31 |
| 11 | 5 | 1.00 | 1.00 | 5.00 | 83.00 | 10.00 | 20 | 25 |
| 11 | 6 | 1.00 | 1.00 | 5.00 | 79.00 | 14.00 | 20 | 30 |
| 11 | 7 | 1.00 | 3.53 | 7.74 | 75.00 | 12.74 | 20 | 30 |
| 11 | 8 | 9.00 | 1.00 | 5.00 | 75.00 | 10.00 | 20 | 31 |
| 11 | 9 | 1.00 | 1.00 | 7.67 | 77.67 | 12.67 | 20 | 16 |
| 11 | 10 | 1.00 | 3.53 | 5.00 | 77.74 | 12.74 | 20 | 62 |
| 11 | 11 | 3.67 | 1.00 | 5.00 | 77.67 | 12.67 | 20 | 34 |
| 11 | 12 | 5.01 | 1.00 | 5.00 | 75.00 | 13.99 | 20 | 28 |
| 12 | 1 | 3.67 | 1.00 | 7.67 | 75.00 | 12.67 | 20 | 42 |
| 12 | 2 | 1.00 | 1.00 | 9.00 | 75.00 | 14.00 | 20 | 72 |
| 12 | 3 | 1.00 | 1.00 | 7.67 | 77.67 | 12.67 | 20 | 43 |
| 12 | 4 | 6.78 | 3.22 | 5.00 | 75.00 | 10.00 | 20 | 56 |
| 12 | 5 | 1.00 | 1.00 | 9.00 | 79.00 | 10.00 | 20 | 38 |
| 12 | 6 | 6.78 | 3.22 | 5.00 | 75.00 | 10.00 | 20 | 43 |
| 13 | 1 | 1.00 | 1.00 | 5.00 | 75.00 | 18.00 | 25 | 34 |
| 13 | 2 | 3.82 | 3.13 | 8.05 | 75.00 | 10.00 | 25 | 36 |
| 13 | 3 | 3.14 | 5.00 | 5.00 | 75.00 | 11.86 | 25 | 27 |
| 13 | 4 | 5.00 | 1.00 | 9.00 | 75.00 | 10.00 | 25 | 35 |
| 13 | 5 | 3.82 | 3.13 | 5.00 | 75.00 | 13.05 | 25 | 28 |
| 13 | 6 | 9.00 | 1.00 | 5.00 | 75.00 | 10.00 | 25 | 34 |
| 13 | 7 | 1.00 | 1.00 | 5.00 | 83.00 | 10.00 | 25 | 19 |
| 13 | 8 | 3.14 | 5.00 | 6.86 | 75.00 | 10.00 | 25 | 29 |
| 13 | 9 | 3.14 | 5.00 | 5.00 | 75.00 | 11.86 | 25 | 40 |
| 13 | 10 | 1.00 | 1.00 | 5.00 | 79.00 | 14.00 | 25 | 26 |
| 13 | 11 | 3.67 | 1.00 | 7.67 | 75.00 | 12.67 | 25 | 31 |
| 13 | 12 | 3.82 | 3.13 | 8.05 | 75.00 | 10.00 | 25 | 38 |
| 14 | 1 | 1.00 | 5.00 | 5.00 | 79.00 | 10.00 | 25 | 26 |
| 14 | 2 | 5.00 | 1.00 | 5.00 | 75.00 | 14.00 | 25 | 27 |
| 14 | 3 | 5.00 | 1.00 | 5.00 | 75.00 | 14.00 | 25 | 22 |
| 14 | 4 | 1.00 | 1.00 | 7.67 | 77.67 | 12.67 | 25 | 26 |
| 14 | 5 | 1.00 | 5.00 | 5.00 | 79.00 | 10.00 | 25 | 22 |
| 14 | 6 | 5.00 | 1.00 | 9.00 | 75.00 | 10.00 | 25 | 34 |
| 14 | 7 | 1.00 | 1.00 | 9.00 | 75.00 | 14.00 | 25 | 34 |
| 14 | 8 | 1.00 | 3.23 | 5.00 | 80.77 | 10.00 | 25 | 22 |
| 14 | 9 | 5.00 | 1.00 | 5.00 | 79.00 | 10.00 | 25 | 30 |
| 14 | 10 | 3.67 | 1.00 | 7.67 | 77.67 | 10.00 | 25 | 29 |
| 14 | 11 | 5.75 | 4.25 | 5.00 | 75.00 | 10.00 | 25 | 36 |
| 14 | 12 | 1.00 | 4.74 | 9.26 | 75.00 | 10.00 | 25 | 37 |
| 15 | 1 | 1.00 | 3.67 | 5.00 | 77.67 | 12.67 | 25 | 37 |
| 15 | 2 | 1.00 | 1.00 | 9.00 | 79.00 | 10.00 | 25 | 32 |
| 15 | 3 | 1.00 | 4.74 | 9.26 | 75.00 | 10.00 | 25 | 45 |
| 15 | 4 | 1.00 | 3.23 | 5.00 | 80.77 | 10.00 | 25 | 28 |
| 15 | 5 | 1.00 | 4.74 | 5.00 | 75.00 | 14.26 | 25 | 31 |
| 15 | 6 | 1.00 | 3.67 | 7.67 | 75.00 | 12.67 | 25 | 34 |
| 15 | 7 | 3.67 | 3.67 | 5.00 | 77.67 | 10.00 | 25 | 31 |
| 15 | 8 | 3.67 | 1.00 | 5.00 | 77.67 | 12.67 | 25 | 46 |
| 15 | 9 | 1.00 | 3.67 | 7.67 | 77.67 | 10.00 | 25 | 27 |
| 15 | 10 | 1.00 | 1.00 | 5.00 | 75.00 | 18.00 | 25 | 56 |
| 15 | 11 | 1.00 | 1.00 | 13.00 | 75.00 | 10.00 | 25 | 29 |

¹Fisher Activated Carbon (derived from coal) throughout Tables 1 and 2

TABLE 2
High Throughput Data from NaBH₄, CoCl₂,
Ru on activated carbon, Sodium hydroxide

| Plate | Vial | | | | | | |
|---|---|---|---|---|---|---|---|
| Num- | Num- | | | | | Malic | Percent |
| ber | ber | SBH | NaOH | CoCl₂ | Ru_on_C | acid | Foam |
| 1 | 1 | 0.9 | 0.05 | 0.01 | 0.04 | 5 | 10 |
| 1 | 2 | 0.75 | 0.05 | 0.0961 | 0.1039 | 5 | 69 |
| 1 | 3 | 0.827 | 0.05 | 0.01 | 0.113 | 5 | 71 |
| 1 | 4 | 0.75 | 0.05 | 0.01 | 0.19 | 5 | 72 |
| 1 | 5 | 0.7808 | 0.15 | 0.01 | 0.0592 | 5 | 15 |
| 1 | 6 | 0.865 | 0.05 | 0.075 | 0.01 | 5 | 9 |
| 1 | 7 | 0.75 | 0.14 | 0.1 | 0.01 | 5 | 33 |
| 1 | 8 | 0.8867 | 0.0933 | 0.01 | 0.01 | 5 | 11 |
| 1 | 9 | 0.8 | 0.09 | 0.1 | 0.01 | 5 | 10 |
| 1 | 10 | 0.75 | 0.1251 | 0.01 | 0.1149 | 5 | 61 |
| 1 | 11 | 0.75 | 0.11 | 0.07 | 0.07 | 5 | 15 |
| 1 | 12 | 0.83 | 0.15 | 0.01 | 0.01 | 5 | 7 |
| 2 | 1 | 0.7878 | 0.15 | 0.0522 | 0.01 | 5 | 17 |
| 2 | 2 | 0.8024 | 0.05 | 0.1 | 0.0476 | 5 | 67 |
| 2 | 3 | 0.7808 | 0.15 | 0.01 | 0.0592 | 5 | 66 |
| 2 | 4 | 0.8092 | 0.05 | 0.0567 | 0.0841 | 5 | 71 |
| 2 | 5 | 0.865 | 0.05 | 0.075 | 0.01 | 5 | 18 |
| 2 | 6 | 0.8169 | 0.1009 | 0.01 | 0.0722 | 5 | 68 |
| 3 | 1 | 0.8841 | 0.05 | 0.0559 | 0.01 | 10 | 11 |
| 3 | 2 | 0.84 | 0.05 | 0.1 | 0.01 | 10 | 8 |
| 3 | 3 | 0.75 | 0.05 | 0.1 | 0.1 | 10 | 66 |
| 3 | 4 | 0.75 | 0.107 | 0.01 | 0.133 | 10 | 59 |
| 3 | 5 | 0.83 | 0.15 | 0.01 | 0.01 | 10 | 59 |
| 3 | 6 | 0.8099 | 0.05 | 0.0701 | 0.07 | 10 | 37 |
| 3 | 7 | 0.75 | 0.15 | 0.01 | 0.09 | 10 | 59 |
| 3 | 8 | 0.8114 | 0.1065 | 0.0721 | 0.01 | 10 | 41 |
| 3 | 9 | 0.75 | 0.05 | 0.01 | 0.19 | 10 | 9 |
| 3 | 10 | 0.9 | 0.08 | 0.01 | 0.01 | 10 | 13 |
| 3 | 11 | 0.75 | 0.05 | 0.0581 | 0.1419 | 10 | 45 |
| 3 | 12 | 0.75 | 0.05 | 0.0581 | 0.1419 | 10 | 37 |
| 4 | 1 | 0.812 | 0.1065 | 0.01 | 0.0715 | 10 | 54 |
| 4 | 2 | 0.75 | 0.14 | 0.1 | 0.01 | 10 | 12 |
| 4 | 3 | 0.83 | 0.05 | 0.01 | 0.11 | 10 | 27 |
| 4 | 4 | 0.8114 | 0.1065 | 0.0721 | 0.01 | 10 | 12 |
| 4 | 5 | 0.8841 | 0.05 | 0.0559 | 0.01 | 10 | 23 |
| 4 | 6 | 0.7725 | 0.15 | 0.0384 | 0.0391 | 10 | 28 |
| 4 | 7 | 0.75 | 0.1053 | 0.0732 | 0.0715 | 10 | 72 |
| 4 | 8 | 0.9 | 0.05 | 0.01 | 0.04 | 10 | 21 |
| 5 | 1 | 0.75 | 0.15 | 0.01 | 0.09 | 15 | 60 |
| 5 | 2 | 0.75 | 0.05 | 0.01 | 0.19 | 15 | 66 |
| 5 | 3 | 0.83 | 0.15 | 0.01 | 0.01 | 15 | 38 |
| 5 | 4 | 0.8829 | 0.05 | 0.0571 | 0.01 | 15 | 66 |
| 5 | 5 | 0.9 | 0.08 | 0.01 | 0.01 | 15 | 21 |
| 5 | 6 | 0.8829 | 0.05 | 0.0571 | 0.01 | 15 | 51 |
| 5 | 7 | 0.81 | 0.11 | 0.07 | 0.01 | 15 | 14 |
| 5 | 8 | 0.81 | 0.11 | 0.01 | 0.07 | 15 | 62 |
| 5 | 9 | 0.75 | 0.1053 | 0.01 | 0.1347 | 15 | 68 |
| 5 | 10 | 0.75 | 0.05 | 0.1 | 0.1 | 15 | 52 |
| 5 | 11 | 0.8153 | 0.05 | 0.0578 | 0.0769 | 15 | 70 |
| 5 | 12 | 0.84 | 0.05 | 0.1 | 0.01 | 15 | 46 |
| 6 | 1 | 0.8298 | 0.05 | 0.01 | 0.1102 | 15 | 35 |
| 6 | 2 | 0.9 | 0.05 | 0.01 | 0.04 | 15 | 21 |
| 6 | 3 | 0.75 | 0.15 | 0.05 | 0.05 | 15 | 45 |
| 6 | 4 | 0.75 | 0.14 | 0.1 | 0.01 | 15 | 64 |
| 6 | 5 | 0.75 | 0.05 | 0.0614 | 0.1386 | 15 | 71 |
| 6 | 6 | 0.75 | 0.1 | 0.0806 | 0.0694 | 15 | 53 |
| 6 | 7 | 0.7946 | 0.05 | 0.1 | 0.0554 | 15 | 27 |
| 7 | 8 | 0.9 | 0.05 | 0.01 | 0.04 | 20 | 40 |
| 7 | 9 | 0.75 | 0.15 | 0.01 | 0.09 | 20 | 19 |
| 7 | 10 | 0.75 | 0.14 | 0.1 | 0.01 | 20 | 46 |
| 7 | 11 | 0.8288 | 0.05 | 0.01 | 0.1112 | 20 | 35 |
| 7 | 12 | 0.75 | 0.1034 | 0.01 | 0.1366 | 20 | 36 |
| 8 | 1 | 0.8525 | 0.1275 | 0.01 | 0.01 | 20 | 18 |
| 8 | 2 | 0.75 | 0.11 | 0.07 | 0.07 | 20 | 62 |
| 8 | 3 | 0.9 | 0.05 | 0.04 | 0.01 | 20 | 23 |
| 8 | 4 | 0.7961 | 0.0939 | 0.1 | 0.01 | 20 | 28 |
| 8 | 5 | 0.7922 | 0.15 | 0.0478 | 0.01 | 20 | 37 |
| 8 | 6 | 0.81 | 0.11 | 0.01 | 0.07 | 20 | 30 |
| 9 | 1 | 0.8015 | 0.0885 | 0.1 | 0.01 | 25 | 18 |
| 9 | 2 | 0.83 | 0.15 | 0.01 | 0.01 | 25 | 17 |
| 9 | 3 | 0.75 | 0.05 | 0.01 | 0.19 | 25 | 37 |
| 9 | 4 | 0.8015 | 0.0885 | 0.1 | 0.01 | 25 | 69 |
| 9 | 5 | 0.75 | 0.15 | 0.01 | 0.09 | 25 | 34 |
| 9 | 6 | 0.75 | 0.14 | 0.1 | 0.01 | 25 | 21 |
| 9 | 7 | 0.75 | 0.1047 | 0.01 | 0.1353 | 25 | 60 |
| 9 | 8 | 0.9 | 0.05 | 0.01 | 0.04 | 25 | 48 |
| 9 | 9 | 0.75 | 0.05 | 0.0845 | 0.1155 | 25 | 49 |
| 9 | 10 | 0.81 | 0.05 | 0.07 | 0.07 | 25 | 53 |
| 9 | 11 | 0.8539 | 0.05 | 0.0861 | 0.01 | 25 | 17 |
| 9 | 12 | 0.8539 | 0.05 | 0.0861 | 0.01 | 25 | 17 |
| 10 | 1 | 0.75 | 0.1024 | 0.0559 | 0.0917 | 25 | 46 |
| 10 | 2 | 0.75 | 0.15 | 0.0532 | 0.0468 | 25 | 29 |
| 10 | 3 | 0.8145 | 0.1174 | 0.0582 | 0.01 | 25 | 13 |
| 10 | 4 | 0.9 | 0.08 | 0.01 | 0.01 | 25 | 10 |
| 10 | 5 | 0.75 | 0.1047 | 0.01 | 0.1353 | 25 | 47 |
| 10 | 6 | 0.81 | 0.11 | 0.01 | 0.07 | 25 | 43 |
| 10 | 7 | 0.8289 | 0.05 | 0.01 | 0.1111 | 25 | 40 |
| 10 | 8 | 0.75 | 0.0876 | 0.1 | 0.0624 | 25 | 43 |
| 10 | 9 | 0.8145 | 0.1174 | 0.0582 | 0.01 | 25 | 26 |

The following formulations were tested. Table 3 describes the formulation ingredients and Table 4 the carbons used in the formulations.

TABLE 3
Solid fuel formulations

| | | | | | % Activated |
|---|---|---|---|---|---|
| number | % SBH | % CoCl₂ | % RuCl₃ | % NaOH | Carbon |
| 1 | 80 | 8 | 2 | 0 | 10 |
| 2 | 75 | 10 | 0 | 5 | 10 |
| 3 | 78.5 | 1 | 1 | 7.89 | 11.5 |

TABLE 4
Carbons

| Carbon | Company | Material | Source |
|---|---|---|---|
| Type CPG 2 × 40 | Calgon | Activated Carbon | coal |
| Black Pearls 2000 | Cabot | Carbon black | oil |
| HG-40 | Westvaco | Activated Carbon | |
| Norit PK 0.25-1 | Norit | Activated Carbon | |
| Darco G-60 | Aldrich | Activated Carbon | lignite |
| GAC 830 Plus | Norit | Activated Carbon | coal |
| GP-3218 | Cabot | Carbon black | oil |
| Mogul L | Cabot | Carbon black | oil |
| BPL F3 DR | Calgon | Activated Carbon | coal |
| HGR P 4 × 10 | Calgon | Activated Carbon | coal |
| BX 7540 | Westvaco | Activated Carbon | |
| AP3-60 | Calgon | Activated Carbon | coal |
| Norit R1 Extra | Norit | Carbon black | peat |
| Centaur 4 × 6 | Calgon | Activated Carbon | coal |
| WV-A 1500 10 × 25 Mesh | Westvaco | Activated Carbon | |
| WV-B 1500 10 × 25 Mesh | Westvaco | Activated Carbon | |
| Vulcan XC 72/GRC-11 | Cabot | Carbon black | coconut |
| Fisher | Fisher | graphite | graphite |
| Fisher | Fisher | Activated carbon | |

An analysis of the high throughput foam height results generated from each fuel, formation/activated carbon and acid combination, giving a point for each combination that produced a foam height greater than 70% and less than 50%, results in Table 5. The complete high-throughput results are presented below in Table 9.

TABLE 5
Tabulation of fuel formulation systems that have low and high
foam heights

| | # of trials | |
|---|---|---|
| | when the foam is | # of trials when the form |
| | less than 50% | is Greater than 75% |
| AP3-60 | 8 | 1 |
| Centaur 4 × 6 | 10 | 1 |
| HGR P 4 × 10 | 8 | 1 |
| BPL F3 DR | 4 | 2 |
| GAC 830 Plus | 5 | 2 |
| Type CPG 2 × 40 | 4 | 3 |
| Vulcan XC 72/GRC-11 | 6 | 3 |
| Norit R1 Extra | 6 | 4 |
| WV-A 1500 10 × 25 Mesh | 2 | 4 |
| BX 7540 | 7 | 5 |
| HG-40 | 2 | 5 |
| Norit PK 0.25-1 | 3 | 6 |
| WV-B 1500 10 × 25 Mesh | 4 | 6 |
| Darco G-60 | 0 | 7 |
| Black Pearls 2000 | 1 | 8 |
| Mogul L | 1 | 11 |
| GP-3218 | 0 | 12 |

This analysis demonstrates that fuel formulations containing AP3-60, Centaur 4×6 and HGR P4×10 resulted in formulations that generated the least amount of foam while formulation made with Back Pearls 2000, Darco G-60, GP-3218 and Mogul L generate the most foam.

To verify the data generated by the high throughput foaming studies, higher precision foaming studies were done on the carbons that showed the best and worst performance i.e. Fisher Activated carbon, HGR-P, Centaur 4×6, Black Pearls 2000 and Mogul L. The data collected from these studies are shown in Table 6.

TABLE 6
High Precision data

| | | % | Stop | Start | energy | water | Fuel | | |
|---|---|---|---|---|---|---|---|---|---|
| | | Malic | Time | Time | density | utilization | utilization | Wt % | Total |
| Carbon | fuel | acid | (sec) | (sec) | Wh/L | (x) H₂O | yield mL | H₂ | Foam |
| Fisher AC | 1 | 15 | 580 | 1 | 758 | 6.1 | 97.5 | 5 | 111.1 |
| HGR-P | 1 | 15 | 420 | 1 | 683 | 6.4 | 82.7 | 4.1 | 121.1 |
| Centaur 4x6 | 1 | 15 | 480 | 1 | 753 | 5.89 | 89.9 | 4.5 | 123.1 |
| Black Pearls | 1 | 15 | 300 | 1 | 567 | 10.6 | 75.4 | 3.4 | 146.3 |
| Mogul L | 1 | 15 | 420 | 1 | 550 | 10.6 | 73.1 | 4.4 | 149.2 |
| Fisher AC | 1 | 20 | 240 | 1 | 717 | 6.8 | 99.2 | 4.3 | 116.8 |
| Centaur 4x6 | 1 | 20 | 480 | 1 | 821 | 5.6 | 100.0 | 4.9 | 127.4 |
| Mogul L | 1 | 20 | 420 | 1 | 712 | 6.9 | 84.9 | 4.3 | 142.1 |
| Black Pearls | 1 | 20 | 480 | 1 | 588 | 11.3 | 65.6 | 3.3 | 148.4 |
| HGR-P | 1 | 20 | 60 | 1 | 364 | 14.1 | 73.7 | 2.2 | 165.7 |
| Fisher AC | 1 | 25 | 480 | 1 | 780 | 6.6 | 98.6 | 4.7 | 106.6 |
| HGR-P | 1 | 25 | 540 | 1 | 807 | 6.1 | 96.9 | 4.8 | 128.7 |
| Centaur 4x6 | 1 | 25 | 420 | 1 | 789 | 5.7 | 99.8 | 4.2 | 131.4 |
| Mogul L | 1 | 25 | 540 | 1 | 701 | 7.1 | 88.0 | 4.2 | 148.7 |
| Black Pearls | 1 | 25 | 420 | 1 | 539 | 11.3 | 65.0 | 3.2 | 156.2 |
| Fisher AC | 2 | 15 | 540 | 1 | 832 | 5.7 | 99.6 | 4.6 | 112.7 |
| Centaur 4x6 | 2 | 15 | 480 | 1 | 816 | 5.6 | 99.8 | 4.9 | 127.2 |
| HGR-P | 2 | 15 | 360 | 1 | 555 | 7.6 | 77.3 | 3.3 | 128.9 |
| Black Pearls | 2 | 15 | 480 | 1 | 541 | 10.5 | 66.6 | 3.3 | 147.9 |
| Mogul L | 2 | 15 | >600 | 1 | 702 | 7.2 | 89.2 | 4.2 | 158.8 |
| Fisher AC | 2 | 20 | 420 | 1 | 781 | 6.2 | 100 | 4.7 | 111 |
| Black Pearls | 2 | 20 | 240 | 1 | 626 | 9.6 | 79.3 | 2.8 | 138.2 |
| Centaur 4x6 | 2 | 20 | 120 | 1 | 411 | 12.8 | 61.0 | 2.5 | 143.4 |
| HGR-P | 2 | 20 | 120 | 1 | 409 | 13.5 | 59.3 | 2.5 | 149.2 |
| Mogul L | 2 | 20 | >600 | 1 | 657 | 7.2 | 88.3 | 4.1 | 152.1 |
| Fisher AC | 2 | 25 | 360 | 1 | 784 | 6.1 | 99.3 | 4.7 | 108.6 |
| Centaur 4x6 | 2 | 25 | 480 | 1 | 791 | 5.5 | 96.2 | 3.9 | 130.2 |
| HGR-P | 2 | 25 | 420 | 1 | 704 | 7.2 | 97.1 | 4.2 | 138.8 |
| Mogul L | 2 | 25 | >600 | 1 | 649 | 8.1 | 82.6 | 3.9 | 149.8 |
| Black Pearls | 2 | 25 | 420 | 1 | 532 | 11 | 68.0 | 3.2 | 163.6 |
| HGR-P | 3 | 15 | 480 | 1 | 552 | 8.2 | 68.1 | 3.2 | 119.9 |
| Fisher AC | 3 | 15 | >600 | 1 | 771 | 6.9 | 99 | 4.7 | 141 |
| Centaur 4x6 | 3 | 15 | >600 | 1 | 802 | 6.1 | 95.6 | 4.8 | 168.7 |
| Black Pearls | 3 | 15 | 360 | 1 | 410 | 12.8 | 20.0 | 2.5 | 181.0 |
| Mogul L | 3 | 15 | >600 | 1 | 557 | 11.1 | 86.2 | 3.4 | 217.9 |
| HGR-P | 3 | 20 | 420 | 1 | 640 | 7.2 | 75.2 | 3.8 | 115.7 |
| Fisher AC | 3 | 20 | 480 | 1 | 806 | 6.3 | 98 | 4.8 | 118 |
| Centaur 4x6 | 3 | 20 | 420 | 1 | 803 | 6 | 84.5 | 4.8 | 128.8 |
| Black Pearls | 3 | 20 | 360 | 1 | 557 | 10.7 | 62.8 | 3.4 | 149.4 |
| Mogul L | 3 | 20 | >600 | 1 | 652 | 7.9 | 77.9 | 3.9 | 204.4 |
| Fisher AC | 3 | 25 | >600 | 1 | 778 | 6.4 | 92 | 4.6 | 121 |
| HGR-P | 3 | 25 | 360 | 1 | 641 | 8.8 | 90.9 | 4.7 | 125.2 |
| Centaur 4x6 | 3 | 25 | >600 | 1 | 777 | 7.1 | 92.1 | 4.7 | 141.4 |
| Mogul L | 3 | 25 | >600 | 1 | 609 | 7.4 | 85.1 | 4.1 | 171.4 |
| Black Pearls | 3 | 25 | 480 | 1 | 432 | 13.5 | 55.7 | 2.56 | 178.0 |

Fuel utilization yield measured as H₂ actual/theory

### Analysis of Carbons:

XPS—the % carbon in each of the samples was determined by subtracting the total amount of other elements detected from 100%. Samples were heated in a 120° C. oven for 24 hours before being analyzed on a Thermo K Alpha X-ray photo spectrometer.
BET surface area analysis was used to determine the specific surface area of the samples. Samples were analyzed as received using a Micromeritics ASAP 2020 sorptometer BET analyzer.
Surface analysis of the carbons by X-ray photoelectron spectroscopy showed a good correlation between the elements present at the surface of the carbon and the observed total foam data collected. (Table 7)

TABLE 7
X-ray photoelectron spectroscopy data

| | % O | % O | | | | | % S | % S | | |
|---|---|---|---|---|---|---|---|---|---|---|
| Carbon | organic | inorganic | % C | % Al | % N | % Na | ox | red | % Si | % Fe |
| AP3-60 | 4.1 | 3.9 | 88.0 | 2.2 | nd | nd | nd | nd | 1.7 | nd |
| std dev | 1.7 | 1.1 | 0.7 | 0.6 | | | | | 0.7 | |
| Black Pearls 2000 | 0.6 | 0.6 | 97.9 | nd | nd | nd | 0.3 | 0.6 | nd | nd |
| std dev | 0.5 | 0.2 | 0.5 | | | | 0.1 | 0.1 | | |
| BPL F3 DR | 2.0 | 5.1 | 87.5 | 1.5 | nd | nd | 0.5 | 1.1 | 2.5 | nd |
| std dev | 0.7 | 0.9 | 1.5 | 0.6 | | | 0.3 | 0.7 | 0.5 | |
| BX 7540 | 3.2 | 3.2 | 91.0 | nd | nd | 1.0 | nd | nd | nd | nd |
| std dev | 1.8 | 0.9 | 0.4 | | | 0.2 | | | | |
| Centaur 4x6 | 5.5 | 2.0 | 88.9 | 0.3 | 0.8 | nd | 0.1 | 1.0 | 1.4 | nd |
| std dev | 1.4 | 1.4 | 2.3 | 0.4 | 0.6 | | | 0.4 | 1.0 | |
| Darco G-60 | 3.3 | 4.3 | 88.1 | 1.0 | nd | nd | 0.5 | 0.6 | 2.0 | nd |
| std dev | 0.7 | 0.7 | 0.7 | 0.4 | | | 0.4 | 0.5 | 0.9 | |
| GAC 830 Plus | 5.9 | 2.6 | 87.4 | nd | nd | nd | 0.2 | 1.2 | 2.0 | nd |
| std dev | 1.3 | 1.4 | 1.4 | | | | 0.1 | 0.7 | 1.1 | |
| GP-3218 | 2.3 | 0.8 | 94.4 | nd | 0.2 | nd | 0.4 | 1.8 | nd | nd |
| std dev | 4.5 | 0.5 | 3.9 | | 0.2 | | 0.3 | 0.4 | | |
| HG-40 | 3.6 | nd | 96.0 | nd | 0.4 | nd | nd | nd | nd | nd |
| std dev | 0.2 | | 0.2 | | 0.4 | | | | | |
| HGR P 4x10 | nd | 5.5 | 80.5 | nd | 0.0 | nd | 1.9 | 10.9 | 1.5 | nd |
| std dev | | 0.9 | 1.8 | | | | 0.5 | 1.5 | 0.9 | |
| Mogul L | 3.1 | 1.0 | 94.0 | 0.0 | 0.5 | nd | 0.5 | 1.0 | nd | nd |
| std dev | 1.9 | 0.4 | 1.8 | | 0.3 | | 0.2 | 0.5 | | |
| Norit PK 0.25-1 | 6.1 | 0.9 | 92.2 | nd | nd | nd | nd | nd | 0.8 | nd |
| std dev | 1.5 | 0.7 | 1.1 | | | | | | 0.6 | |
| Norit R1 Extra | 5.9 | 1.0 | 91.8 | nd | nd | nd | 0.0 | 0.5 | 0.8 | nd |
| std dev | 1.5 | 1.0 | 1.2 | | | | | 0.5 | 0.9 | |
| Type CPG 2x40 | 4.9 | 3.1 | 88.5 | nd | nd | nd | 0.2 | 0.9 | 2.4 | nd |
| std dev | 0.9 | 0.8 | 1.4 | | | | 0.2 | 0.6 | 0.6 | |
| Vulcan XC | 5.7 | 1.5 | 91.5 | nd | nd | nd | nd | nd | 1.3 | nd |
| 72/GRC-11 | | | | | | | | | | |
| std dev | 1.9 | 1.0 | 0.3 | | | | | | 0.9 | |
| WV-A 1500 | 6.4 | 4.0 | 86.9 | nd | nd | 0.4 | nd | nd | 0.7 | nd |
| 10x25Mesh | | | | | | | | | | |
| std dev | 1.0 | 0.9 | 0.9 | | | 0.2 | | | 0.5 | |
| WV-B 1500 | 4.7 | 5.7 | 85.7 | nd | nd | 0.4 | nd | nd | 1.6 | nd |
| 10x25Mesh | | | | | | | | | | |
| std dev | 2.7 | 2.2 | 1.3 | | | 0.1 | | | 0.8 | |
| Fisher Activated | 4.5 | 0.7 | 94.1 | nd | nd | nd | 0.3 | 0.3 | nd | nd |
| carbon | | | | | | | | | | |
| std dev | 1.7 | 0.6 | 1.2 | | | | 0.3 | 0.2 | | |
| Fisher Graphite | 2.5 | 0.1 | 97.3 | 0.0 | nd | nd | 0.0 | 0.1 | 0.0 | nd |
| std dev | 0.6 | 0.1 | 0.4 | 0.0 | | | 0.1 | 0.1 | 0.0 | |

TABLE 8
Foam Height data from high throughput experiments

| New | | | | Acid | |
|---|---|---|---|---|---|
| Plate | Cell | For- | | concen- | Percent |
| Number | number | mula | Carbon type | tration | Foam |
| 1 | 1.1 | 1 | AP3-60 | 15 | 30 |
| 1 | 1.2 | 2 | AP3-60 | 15 | 36 |
| 1 | 1.3 | 2 | AP3-60 | 15 | 17 |
| 1 | 1.4 | 3 | AP3-60 | 15 | 20 |
| 1 | 1.5 | 1 | Black Pearls 2000 | 15 | 58 |
| 1 | 1.6 | 2 | Black Pearls 2000 | 15 | 100 |
| 1 | 1.7 | 3 | Black Pearls 2000 | 15 | 100 |
| 1 | 1.8 | 1 | BPL F3 DR | 15 | 54 |
| 1 | 1.9 | 2 | BPL F3 DR | 15 | 32 |
| 1 | 1.1 | 3 | BPL F3 DR | 15 | 26 |
| 1 | 1.11 | 1 | BX 7540 | 15 | 46 |
| 1 | 1.12 | 2 | BX 7540 | 15 | 34 |
| 2 | 2.1 | 3 | BX 7540 | 15 | 22 |
| 2 | 2.2 | 1 | Centaur 4 × 6 | 15 | 46 |
| 2 | 2.3 | 2 | Centaur 4 × 6 | 15 | 31 |
| 2 | 2.4 | 3 | Centaur 4 × 6 | 15 | 48 |
| 2 | 2.5 | 1 | Darco G-60 | 15 | 83 |
| 2 | 2.6 | 2 | Darco G-60 | 15 | 72 |
| 2 | 2.7 | 3 | Darco G-60 | 15 | 50 |
| 2 | 2.8 | 1 | GAC 830 Plus | 15 | 57 |
| 2 | 2.9 | 2 | GAC 830 Plus | 15 | 39 |
| 2 | 2.1 | 3 | GAC 830 Plus | 15 | 30 |
| 2 | 2.11 | 3 | GAC 830 Plus | 15 | 22 |
| 2 | 2.12 | 1 | GP-3218 | 15 | 99 |
| 3 | 3.1 | 2 | GP-3218 | 15 | 100 |
| 3 | 3.2 | 3 | GP-3218 | 15 | 80 |
| 3 | 3.3 | 1 | HG-40 | 15 | 91 |
| 3 | 3.4 | 2 | HG-40 | 15 | 50 |
| 3 | 3.5 | 3 | HG-40 | 15 | 69 |
| 3 | 3.6 | 1 | HGR P 4 × 10 | 15 | 61 |
| 3 | 3.7 | 2 | HGR P 4 × 10 | 15 | 35 |
| 3 | 3.8 | 3 | HGR P 4 × 10 | 15 | 20 |
| 3 | 3.9 | 1 | Mogul L | 15 | 100 |
| 3 | 3.1 | 2 | Mogul L | 15 | 39 |
| 3 | 3.11 | 3 | Mogul L | 15 | 98 |
| 3 | 3.12 | 1 | Norit PK 0.25-1 | 15 | 75 |
| 4 | 4.1 | 1 | Norit PK 0.25-1 | 15 | 100 |
| 4 | 4.2 | 2 | Norit PK 0.25-1 | 15 | 100 |
| 4 | 4.3 | 2 | Norit PK 0.25-1 | 15 | 55 |
| 4 | 4.4 | 3 | Norit PK 0.25-1 | 15 | 61 |
| 4 | 4.5 | 1 | Norit R1 Extra | 15 | 34 |
| 4 | 4.6 | 2 | Norit R1 Extra | 15 | 38 |
| 4 | 4.7 | 3 | Norit R1 Extra | 15 | 21 |
| 4 | 4.8 | 1 | Type CPG 2 × 40 | 15 | 54 |
| 4 | 4.9 | 2 | Type CPG 2 × 40 | 15 | 54 |
| 4 | 4.1 | 3 | Type CPG 2 × 40 | 15 | 30 |
| 4 | 4.11 | 1 | Vulcan XC 72/GRC-11 | 15 | 48 |
| 4 | 4.12 | 2 | Vulcan XC 72/GRC-11 | 15 | 27 |
| 5 | 5.1 | 3 | Vulcan XC 72/GRC-11 | 15 | 28 |
| 5 | 5.2 | 1 | WV-A 1500 10 × 25 MEsh | 15 | 83 |
| 5 | 5.3 | 2 | WV-A 1500 10 × 25 MEsh | 15 | 73 |
| 5 | 5.4 | 3 | WV-A 1500 10 × 25 MEsh | 15 | 32 |
| 5 | 5.5 | 3 | WV-A 1500 10 × 25 MEsh | 15 | 31 |
| 5 | 5.6 | 1 | WV-B 1500 10 × 25 Mesh | 15 | 100 |
| 5 | 5.7 | 2 | WV-B 1500 10 × 25 Mesh | 15 | 40 |
| 5 | 5.8 | 3 | WV-B 1500 10 × 25 Mesh | 15 | 34 |
| 6 | 6.1 | 1 | AP3-60 | 20 | 100 |
| 6 | 6.2 | 2 | AP3-60 | 20 | 44 |
| 6 | 6.3 | 3 | AP3-60 | 20 | 22 |
| 6 | 6.4 | 1 | Black Pearls 2000 | 20 | 72 |
| 6 | 6.5 | 2 | Black Pearls 2000 | 20 | 97 |
| 6 | 6.6 | 3 | Black Pearls 2000 | 20 | 40 |
| 6 | 6.7 | 1 | BPL F3 DR | 20 | 52 |
| 6 | 6.8 | 1 | BPL F3 DR | 20 | 70 |
| 6 | 6.9 | 2 | BPL F3 DR | 20 | 30 |
| 6 | 6.1 | 3 | BPL F3 DR | 20 | 34 |
| 6 | 6.11 | 1 | BX 7540 | 20 | 87 |
| 6 | 6.12 | 2 | BX 7540 | 20 | 38 |
| 7 | 7.1 | 3 | BX 7540 | 20 | 25 |
| 7 | 7.2 | 1 | Centaur 4 × 6 | 20 | 45 |
| 7 | 7.3 | 2 | Centaur 4 × 6 | 20 | 35 |
| 7 | 7.4 | 3 | Centaur 4 × 6 | 20 | 23 |
| 7 | 7.5 | 3 | Centaur 4 × 6 | 20 | 27 |
| 7 | 7.6 | 1 | Darco G-60 | 20 | 99 |
| 7 | 7.7 | 2 | Darco G-60 | 20 | 84 |
| 7 | 7.8 | 3 | Darco G-60 | 20 | 64 |
| 7 | 7.9 | 1 | GAC 830 Plus | 20 | 61 |
| 7 | 7.1 | 1 | GAC 830 Plus | 20 | 69 |
| 7 | 7.11 | 2 | GAC 830 Plus | 20 | 42 |
| 7 | 7.12 | 3 | GAC 830 Plus | 20 | 43 |
| 8 | 8.1 | 1 | GP-3218 | 20 | 99 |
| 8 | 8.2 | 2 | GP-3218 | 20 | 100 |
| 8 | 8.3 | 3 | GP-3218 | 20 | 99 |
| 8 | 8.4 | 1 | HG-40 | 20 | 61 |
| 8 | 8.5 | 1 | HG-40 | 20 | 76 |
| 8 | 8.6 | 2 | HG-40 | 20 | 54 |
| 8 | 8.7 | 3 | HG-40 | 20 | 23 |
| 8 | 8.8 | 1 | HGR P 4 × 10 | 20 | 42 |
| 8 | 8.9 | 2 | HGR P 4 × 10 | 20 | 32 |
| 8 | 8.1 | 3 | HGR P 4 × 10 | 20 | 23 |
| 8 | 8.11 | 1 | Mogul L | 20 | 100 |
| 8 | 8.12 | 2 | Mogul L | 20 | 100 |
| 9 | 9.1 | 3 | Mogul L | 20 | 100 |
| 9 | 9.2 | 1 | Norit PK 0.25-1 | 20 | 95 |
| 9 | 9.3 | 2 | Norit PK 0.25-1 | 20 | 80 |
| 9 | 9.4 | 3 | Norit PK 0.25-1 | 20 | 29 |
| 9 | 9.5 | 1 | Norit R1 Extra | 20 | 84 |
| 9 | 9.6 | 2 | Norit R1 Extra | 20 | 41 |
| 9 | 9.7 | 3 | Norit R1 Extra | 20 | 21 |
| 9 | 9.8 | 1 | Type CPG 2 × 40 | 20 | 57 |
| 9 | 9.9 | 2 | Type CPG 2 × 40 | 20 | 34 |
| 9 | 9.1 | 3 | Type CPG 2 × 40 | 20 | 27 |
| 9 | 9.11 | 1 | Vulcan XC 72/GRC-11 | 20 | 68 |
| 9 | 9.12 | 2 | Vulcan XC 72/GRC-11 | 20 | 23 |
| 10 | 10.1 | 3 | Vulcan XC 72/GRC-11 | 20 | 36 |
| 10 | 10.2 | 1 | WV-A 1500 10 × 25 MEsh | 20 | 62 |
| 10 | 10.3 | 2 | WV-A 1500 10 × 25 mesh | 20 | 56 |
| 10 | 10.4 | 3 | WV-A 1500 10 × 25 mesh | 20 | 69 |
| 10 | 10.5 | 3 | WV-A 1500 10 × 25 mesh | 20 | 43 |
| 10 | 10.6 | 1 | WV-B 1500 10 × 25 mesh | 20 | 71 |
| 10 | 10.7 | 2 | WV-B 1500 10 × 25 mesh | 20 | 45 |
| 10 | 10.8 | 3 | WV-B 1500 10 × 25 mesh | 20 | 22 |
| 11 | 11.1 | 1 | AP3-60 | 25 | 45 |
| 11 | 11.2 | 2 | AP3-60 | 25 | 48 |
| 11 | 11.3 | 3 | AP3-60 | 25 | 60 |
| 11 | 11.4 | 1 | Black Pearlss 2000 | 25 | 100 |
| 11 | 11.5 | 2 | Black Pearls 2000 | 25 | 87 |
| 11 | 11.6 | 3 | Black Pearls 2000 | 25 | 100 |
| 11 | 11.7 | 1 | BPL F3 DR | 25 | 59 |
| 11 | 11.8 | 2 | BPL F3 DR | 25 | 69 |
| 11 | 11.9 | 3 | BPL F3 DR | 25 | 42 |
| 11 | 11.1 | 1 | BX 7540 | 25 | 65 |
| 11 | 11.11 | 1 | BX 7540 | 25 | 91 |
| 11 | 11.12 | 2 | BX 7540 | 25 | 82 |
| 12 | 12.1 | 3 | BX 7540 | 25 | 35 |
| 12 | 12.2 | 1 | Centaur 4 × 6 | 25 | 99 |
| 12 | 12.3 | 2 | Centaur 4 × 6 | 25 | 46 |
| 12 | 12.4 | 3 | Centaur 4 × 6 | 25 | 30 |
| 12 | 12.5 | 1 | Darco G-60 | 25 | 94 |
| 12 | 12.6 | 2 | Darco G-60 | 25 | 77 |
| 12 | 12.7 | 3 | Darco G-60 | 25 | 59 |
| 12 | 12.8 | 3 | Darco G-60 | 25 | 86 |
| 12 | 12.9 | 1 | GAC 830 Plus | 25 | 63 |
| 12 | 12.1 | 2 | GAC 830 Plus | 25 | 74 |
| 12 | 12.11 | 3 | GAC 830 Plus | 25 | 53 |
| 12 | 12.12 | 3 | GAC 830 Plus | 25 | 42 |
| 13 | 13.1 | 1 | GP-3218 | 25 | 99 |
| 13 | 13.2 | 2 | GP-3218 | 25 | 100 |
| 13 | 13.3 | 2 | GP-3218 | 25 | 100 |
| 13 | 13.4 | 3 | GP-3218 | 25 | 100 |
| 13 | 13.5 | 1 | HG-40 | 25 | 50 |
| 13 | 13.6 | 2 | HG-40 | 25 | 79 |
| 13 | 13.7 | 3 | HG-40 | 25 | 43 |
| 13 | 13.8 | 1 | HGR P 4 × 10 | 25 | 47 |
| 13 | 13.9 | 2 | HGR P 4 × 10 | 25 | 62 |
| 13 | 13.1 | 3 | HGR P 4 × 10 | 25 | 18 |
| 13 | 13.11 | 1 | Mogul L | 25 | 100 |
| 13 | 13.12 | 1 | Mogul L | 25 | 100 |
| 14 | 14.1 | 2 | Mogul L | 25 | 98 |
| 14 | 14.2 | 3 | Mogul L | 25 | 100 |
| 14 | 14.3 | 1 | Norit PK 0.25-1 | 25 | 95 |
| 14 | 14.4 | 1 | Norit PK 0.25-1 | 25 | 100 |
| 14 | 14.5 | 2 | Norit PK 0.25-1 | 25 | 45 |
| 14 | 14.6 | 3 | Norit PK 0.25-1 | 25 | 33 |
| 14 | 14.7 | 3 | Norit PK 0.25-1 | 25 | 39 |
| 14 | 14.8 | 1 | Norit R1 Extra | 25 | 84 |
| 14 | 14.9 | 2 | Norit R1 Extra | 25 | 39 |
| 14 | 14.1 | 3 | Norit R1 Extra | 25 | 50 |
| 14 | 14.11 | 1 | Type CPG 2 × 40 | 25 | 100 |
| 14 | 14.12 | 2 | Type CPG 2 × 40 | 25 | 59 |
| 15 | 15.1 | 3 | Type CPG 2 × 40 | 25 | 39 |
| 15 | 15.2 | 3 | Type CPG 2 × 40 | 25 | 48 |
| 15 | 15.3 | 1 | Vulcan XC 72/GRC-11 | 25 | 81 |
| 15 | 15.4 | 2 | Vulcan XC 72/GRC-11 | 25 | 36 |
| 15 | 15.5 | 3 | Vulcan XC 72/GRC-11 | 25 | 26 |
| 15 | 15.6 | 1 | WV-A 1500 10 × 25 mesh | 25 | 65 |
| 15 | 15.7 | 2 | WV-A 1500 10 × 25 mesh | 25 | 65 |
| 15 | 15.8 | 3 | WV-A 1500 10 × 25 mesh | 25 | 52 |
| 15 | 15.9 | 1 | WV-B 1500 10 × 25 mesh | 25 | 69 |
| 15 | 15.1 | 1 | WV-B 1500 10 × 25 mesh | 25 | 97 |
| 15 | 15.11 | 2 | WV-B 1500 10 × 25 mesh | 25 | 92 |
| 15 | 15.12 | 3 | WV-B 1500 10 × 25 mesh | 25 | 54 |
| 16 | 16.1 | 1 | AP3-60 | 30 | 52 |
| 16 | 16.2 | 2 | AP3-60 | 30 | 98 |
| 16 | 16.3 | 2 | AP3-60 | 30 | 35 |
| 16 | 16.4 | 3 | AP3-60 | 30 | 27 |
| 16 | 16.5 | 1 | Black Pearls 2000 | 30 | 81 |
| 16 | 16.6 | 2 | Black Pearls 2000 | 30 | 98 |
| 16 | 16.7 | 3 | Black Pearls 2000 | 30 | 93 |
| 16 | 16.8 | 1 | BPL F3 DR | 30 | 100 |
| 16 | 16.9 | 2 | BPL F3 DR | 30 | 96 |
| 16 | 16.1 | 3 | BPL F3 DR | 30 | 65 |
| 16 | 16.11 | 1 | BX 7540 | 30 | 98 |
| 16 | 16.12 | 2 | BX 7540 | 30 | 88 |
| 17 | 17.1 | 3 | BX 7540 | 30 | 36 |
| 17 | 17.2 | 1 | Centaur 4 × 6 | 30 | 42 |
| 17 | 17.3 | 1 | Centaur 4 × 6 | 30 | 94 |
| 17 | 17.4 | 2 | Centaur 4 × 6 | 30 | 34 |
| 17 | 17.5 | 3 | Centaur 4 × 6 | 30 | 48 |
| 17 | 17.6 | 1 | Darco G-60 | 30 | 92 |
| 17 | 17.7 | 2 | Darco G-60 | 30 | 99 |
| 17 | 17.8 | 3 | Darco G-60 | 30 | 50 |
| 17 | 17.9 | 1 | GAC 830 Plus | 30 | 76 |
| 17 | 17.1 | 2 | GAC 830 Plus | 30 | 98 |
| 17 | 17.11 | 3 | GAC 830 Plus | 30 | 58 |
| 17 | 17.12 | 1 | GP-3218 | 30 | 97 |
| 18 | 18.1 | 2 | GP-3218 | 30 | 89 |
| 18 | 18.2 | 3 | GP-3218 | 30 | 100 |
| 18 | 18.3 | 1 | HG-40 | 30 | 100 |
| 18 | 18.4 | 2 | HG-40 | 30 | 100 |
| 18 | 18.5 | 3 | HG-40 | 30 | 79 |
| 18 | 18.6 | 1 | HGR P 4 × 10 | 30 | 57 |
| 18 | 18.7 | 1 | HGR P 4 × 10 | 30 | 96 |
| 18 | 18.8 | 2 | HGR P 4 × 10 | 30 | 69 |
| 18 | 18.9 | 3 | HGR P 4 × 10 | 30 | 50 |
| 18 | 18.1 | 1 | Mogul L | 30 | 100 |
| 18 | 18.11 | 1 | Mogul L | 30 | 99 |
| 18 | 18.12 | 2 | Mogul L | 30 | 100 |
| 19 | 19.1 | 3 | Mogul L | 30 | 99 |
| 19 | 19.2 | 1 | Norit PK 0.25-1 | 30 | 100 |
| 19 | 19.3 | 2 | Norit PK 0.25-1 | 30 | 73 |
| 19 | 19.4 | 3 | Norit PK 0.25-1 | 30 | 66 |
| 19 | 19.5 | 3 | Norit PK 0.25-1 | 30 | 54 |
| 19 | 19.6 | 1 | Norit R1 Extra | 30 | 90 |
| 19 | 19.7 | 2 | Norit R1 Extra | 30 | 73 |
| 19 | 19.8 | 3 | Norit R1 Extra | 30 | 78 |
| 19 | 19.9 | 1 | Type CPG 2 × 40 | 30 | 99 |
| 19 | 19.1 | 2 | Type CPG 2 × 40 | 30 | 88 |
| 19 | 19.11 | 3 | Type CPG 2 × 40 | 30 | 53 |
| 19 | 19.12 | 1 | Vulcan XC 72/GRC-11 | 30 | 78 |
| 20 | 20.1 | 2 | Vulcan XC 72/GRC-11 | 30 | 72 |
| 20 | 20.2 | 3 | Vulcan XC 72/GRC-11 | 30 | 90 |
| 20 | 20.3 | 1 | WV-A 1500 10 × 25 MEsh | 30 | 86 |
| 20 | 20.4 | 2 | WV-A 1500 10 × 25 MEsh | 30 | 79 |
| 20 | 20.5 | 3 | WV-A 1500 10 × 25 MEsh | 30 | 93 |
| 20 | 20.6 | 1 | WV-B 1500 10 × 25 Mesh | 30 | 85 |
| 20 | 20.7 | 2 | WV-B 1500 10 × 25 Mesh | 30 | 97 |
| 20 | 20.8 | 3 | WV-B 1500 10 × 25 Mesh | 30 | 69 |

1. A method for generation of hydrogen; said method comprising adding a liquid comprising water and at least one organic acid to a solid composition comprising at least one alkali metal borohydride and at least one carbon selected from the group consisting of activated carbon derived from coal and carbon black derived from peat.

2. The method of claim 1 in which the solid composition further comprises at least one salt of a transition metal from group 8, 9 or 10.

3. The method of claim 2 in which in which the solid composition comprises from 65 wt % to 90 wt % of said at least one alkali metal borohydride, from 5 wt % to 20 wt % of said at least one carbon, and from 1 wt % to 15 wt % of said at least one salt of a transition metal from groups 8, 9 and 10.

4. The method of claim 3 in which the solid composition further comprises at least one base in an amount from 1 wt % to 12 wt %.

5. The method of claim 4 in which the solid composition comprises from 70 wt % to 86 wt % of said at least one alkali metal borohydride, from 7 wt % to 15 wt % of said at least one carbon, from 1 wt % to 15 wt % of said at least one transition metal salt from groups 8, 9 and 10; and from 2 wt % to 11 wt % of said at least one base.

6. The method of claim 5 in which in which said at least one alkali metal borohydride is sodium borohydride, potassium borohydride or a combination thereof; said at least one base is an alkali metal hydroxide, alkali metal alkoxide, alkaline earth alkoxide or combination thereof; and said at least one carbon is activated carbon derived from coal.

7. The method of claim 6 in which said at least one carbon contains no more than 94.5 wt % carbon and from 4 wt % to 15 wt % oxygen.

8. The method of claim 7 in which said liquid comprises from 5 wt % to 40 wt % of an organic acid.

9. The method of claim 8 in which said organic acid is a C₂-C₅ dicarboxylic acid, a C₂-C₆ hydroxy carboxylic acid, a C₂-C₆ hydroxy di- or tri-carboxylic acid or a combination thereof.

10. The method of claim 9 in which the solid composition comprises from 70 wt % to 84 wt % of said at least one alkali metal borohydride, from 7 wt % to 13 wt % of said at least one carbon, from 1 wt % to 13 wt % of said at least one transition metal salt from groups 8, 9 and 10; and from 3 wt % to 11 wt % of said at least one base.
